(19) United States
(12) Patent Application Publication
(10) Pub. No.: US 2007/0251447 A1
(43) Pub. Date: Nov. 1, 2007

(54) Reactor and Method for Manufacturing Silicon

(76) Inventors: Armin Muller, Freiberg (DE); Torsten Sill, Freiberg (DE); Raymund Sonnenschein, Frankfurt (DE); Peter Adler, Rheinfelden (DE)

Correspondence Address: MCGLEW & TUTTLE, PC, P.O. BOX 9227, SCARBOROUGH STATION, SCARBOROUGH, NY, 10510-9227, US

(21) Appl. No.: 11/573,061

(22) PCT Filed: Jul. 26, 2005
(86) PCT No.: PCT/EP05/08100

§ 371 Date: Feb. 1, 2007

(30) Foreign Application Priority Data
Aug. 10, 2004 (DE) 10 2004 038 718.4

(51) Int. Cl. C01B 33/035

(52) U.S. Cl. 118/620; 422/129

(57) ABSTRACT

A reactor for separating a gas containing silicon is provided with at least one electrically heatable deposition element of silicon to save costs, which element has a doping with at least one impurity to improve its electrical conductivity, the doping having a concentration in an initial state, such that the deposition element with the silicon deposited thereon in the final state is suitable for the manufacture of silicon melt for the production of polycrystalline silicon blocks or single silicon crystals for photovoltaics. A method for manufacturing silicon with the reactor according to the invention and the use of the manufactured silicon in photovoltaics are also described.

### BACKGROUND OF THE INVENTION

1. Field of the Invention

The invention relates to a reactor for separating a gas containing silicon, particularly monosilane or trichlorosilane. The invention also relates to a method for manufacturing silicon with the reactor according to the invention. Furthermore, the invention relates to the use of the silicon manufactured by the method according to the invention in photovoltaics.

2. Background Art

The manufacture of silicon by the deposition of a gas containing silicon onto the surface of a body has been known for a long time. Such gas-phase deposition processes are generally described as Chemical Vapor Deposition (CVD). Monosilane or trichlorosilane are mainly used as the gas containing silicon. The deposition of the silicon takes place on the surface of a body, which usually consists of high-purity silicon, and must be brought to a deposition temperature of ≧800° C. by heating. The disadvantage with this, however, is that silicon has very low conductivity at temperatures ≦700° C., so that electrical heating of the deposition body proves to be difficult.

The application of high voltage sources or high frequency voltage sources is suggested in the literature as a solution to this problem for the lower temperature range. The energy consumption for the heating of the deposition body of silicon is, however, considerable. Furthermore, the use of a deposition body made of a better electrically conductive material than silicon is suggested in the literature. This material must be stable at high temperatures. The disadvantage with this, however, is that this material contaminates the silicon deposited thereon and must be removed from the silicon again in a costly procedure.

### SUMMARY OF THE INVENTION

The object of the invention is to develop a reactor for separating a gas containing silicon, such that silicon suitable for further processing in photovoltaics can be manufactured in an energy- and cost-saving manner.

The object is achieved by a reactor comprising a reactor vessel which encloses a reaction chamber for the reception of the gas and which has at least one gas supply pipe, at least one heatable deposition element, arranged inside the reaction chamber for the deposition of silicon, the at least one deposition element substantially containing silicon, and having a doping with at least one impurity to improve electrical conductivity, the doping having a concentration in an initial state, such that the deposition element is suitable for the manufacture of silicon melt for the production of polycrystalline silicon blocks or single silicon crystals for photovoltaics in an end state with the silicon deposited thereon, and an electrical heating device to heat the at least one deposition element using a current flow through it. The object is also achieved by a method for manufacturing silicon comprising the following steps: provision of a reactor, heating of the at least one deposition element using the electrical heating device to at least the deposition temperature, supply of the gas containing silicon into the reactor, thermal separation of the gas with the formation of silicon, and deposition of the silicon onto the at least one deposition element. The object is also achieved by the Use of the silicon manufactured for manufacturing silicon melt for the production of polycrystalline silicon blocks or single silicon crystals for photovoltaics.

The core of the invention is that at least one electrically heatable deposition element for the deposition of silicon is doped with at least one impurity, the electrical conductivity of the deposition element thus being improved. The at least one impurity and its concentration in the at least one deposition element is selected in the process, such that doping necessary for the manufacture of solar cells, which doping would have to be introduced into the silicon in a later process, is no longer necessary. The electrical heating can therefore be carried out efficiently and cost-effectively, no additional procedural step, for example the purification of the silicon, being necessary, since the doping of the silicon necessary for its use in photovoltaics simply takes place at an earlier stage.

Additional features, details and advantages of the invention will emerge from the description of two embodiments with reference to the drawings.

### BRIEF DESCRIPTION OF THE DRAWINGS

FIG. 1 shows a longitudinal section through a reactor, according to a first embodiment, and

FIG. 2 shows a longitudinal section through a reactor according to a second embodiment.

### DESCRIPTION OF THE PREFERRED EMBODIMENTS

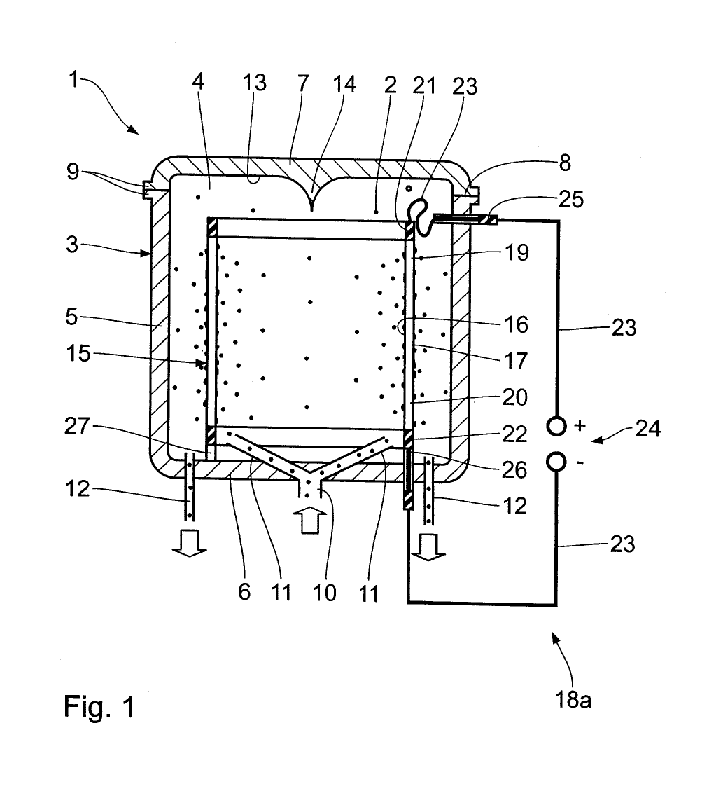

Referring first to FIG. 1, the construction of a reactor 1 for separating a gas 2 containing silicon is described hereinafter. The reactor 1 has a reactor vessel 3, which encloses a reaction chamber 4 and receives the gas 2. The reactor vessel 3 has a tubular, vertical side wall 5, which is tightly closed at its lower end by a base 6. A substantially disc-like, removable lid 7 is arranged at the upper end of the side wall 5, and it closes the reaction chamber 4. An annular seal 8 is provided to seal the reaction chamber 4 at the upper end of the side wall 5, and is accommodated by seal webs 9 projecting with respect to the side wall 5 on the upper end of the side wall 5 and the lid 7. Fixing devices, particularly clips or screws, not shown in more detail, are arranged on the seal webs 9 of the side wall 5 and the lid 7 to fix the lid 7.

A Y-shaped gas supply pipe 10 is fed through the center of the base 6, both supply ends 11 of which feed into the reaction chamber 4. The gas supply pipe 10 can also be configured such that more than two supply ends 11 feed into the reaction chamber 4, the ends 11 defining a circle, about the circumference of which they are arranged equidistantly. Two gas discharge pipes 12 are fed through the base 6 on opposite sides between the pipe ends 11 of the gas supply pipe 10 and the side wall 5. A continuous exchange of the gas 2 is achieved in the reaction chamber 4 through the gas supply pipe 10 and the gas discharge pipe 12. A tapering flow element 14 is arranged centrally on an internal lid wall 13 of the lid 7 and extending into the reactor chamber 4, to optimize the flow inside the reaction chamber 4.

A tubular deposition element 15 of high-purity silicon is placed substantially centrally inside the reaction chamber 4. The deposition element 15 has an inner wall 16 and an outer wall 17, the deposition element 15 being heated by an electrical heating device 18, such that the inner and outer walls 16, 17 have a temperature that enables the deposition of silicon out of the gas 2 onto the inner and outer walls 16, 17. First and second annular contact elements 21, 22 are arranged on lower and upper annular ends 19, 20 of the deposition element 15 for the purpose of heating, and connected conductively to the deposition element 15. The first and second contact elements 21, 22 are conductively connected to opposing poles of a voltage source 24, particularly a DC voltage source, via electrical connecting lines 23. The connecting lines 23 are fed into the reaction chamber 4 using first and second tubular current feedthroughs 25, 26. The current feedthroughs 25, 26 are sealed, such that no gas 2 can escape from the reaction chamber 4. The first current feedthrough 25 is arranged in the side wall 5, substantially at the height of the first contact element 21. The connecting line 23 issuing therefrom is constructed flexibly at least as far as the first contact element 21. The second current feedthrough 26 is fed through the base 6 near the second contact element 22 and connected directly to the second contact element 22. The connecting line 23 to the second contact element 22 therefore runs inside the current feedthrough 26 the whole way. The heating device 18 encloses the first and second contact elements 21, 22, the connecting lines 23, the voltage source 24 and the first and second current feedthroughs 25, 26.

The deposition element 15 is fixed using an electrically insulated, substantially annular bearing element 27. The bearing element 27 is fixed on the base 6 inside the reaction chamber 4 and carries the deposition element 15, which rests on the bearing element 27 with the second contact element 22 and is fixed there. The bearing element 27 is interrupted in the region of the current feedthrough 26.

The deposition element 15 is doped with an impurity; boron, aluminum, gallium, indium, phosphorus, arsenic and antimony being particularly suitable. The doping can either be carried out with one of these impurities or with a combination of a plurality of impurities. The doping, for example with boron, is carried out at a concentration of 1.3·10¹⁷ to 1.2·10²¹ atoms per cm³, preferably 2.7·10¹⁷ to 4.4·10²⁰ atoms per cm³ and more preferably 9.5·10¹⁷ to 1.4·10²⁰ atoms per cm³. At ambient temperature, these concentrations correspond to a specific resistance of 0.0001 Ohm cm to 0.17 Ohm cm, preferably 0.0003 Ohm cm to 0.1 Ohm cm and more preferably 0.0008 Ohm cm to 0.045 Ohm cm of the deposition element 15 in its initial state, i.e. before silicon is deposited thereon.

The tubular deposition element 15 typically has a diameter of 300 mm in its initial state and a wall thickness of 0.3 mm to 1.0 mm. In its final state, i.e. after the deposition of the desired quantity of silicon, the wall thickness of the deposition element 15 has typically increased to 100 mm to 200 mm. This corresponds to a ratio of 1:100 to 1:667 between the volume of the initial state and the volume of the final state. A rod-shaped deposition element 15 constructed as a full cylinder can also be provided. The rod-shaped deposition element 15 has a diameter of 5 mm to 10 mm in its initial state and a diameter of 100 mm to 330 mm in its final state. This corresponds to a ratio of the volume in the initial state to the volume in the final state of 1:100 to 1:4356.

Other configurations of the deposition element 15 are possible in principle, for example a tubular deposition element 15 with a polygonal cross section with at least three corners.

In its final state with the deposited silicon, the deposition element 15 has a doping, for example of boron, with a concentration of 1.3·10¹⁵ to 2.8·10¹⁷ atoms per cm³, preferably 2.7·10¹⁵ to 1.0·10¹⁷ atoms per cm³ and more preferably 9.5·10¹⁵ to 3.2·10¹⁶ atoms per cm³. This corresponds to a specific resistance of the deposition element 15 in its final state of 0.1 Ohm cm to 10 Ohm cm, preferably 0.2 Ohm cm to 5 Ohm cm and more preferably 0.5 Ohm cm to 1.5 Ohm cm at ambient temperature. The concentration of the doping has therefore decreased in the final state in comparison to the initial state, as a result of the deposited silicon. In contrast to this, the specific resistance has increased as a result of the lower concentration of the doping. At the concentration in the final state, the deposition element 15 is suitable for the manufacture of silicon melt for the production of polycrystalline silicon blocks or single silicon crystals for photovoltaics, especially for the manufacture of solar cells.

The method of manufacturing silicon with the reactor 1 is described hereinafter in more detail. The doped deposition element 15 is first guided into the reactor chamber 4 with the lid 7 open and fixed onto the bearing element 27. The contact elements 21, 22, which have already been installed, are then electrically conductively connected to the connecting lines 23. After the deposition element 15 has been placed into the reaction chamber 4 and fixed, the lid 7 is closed tight. The reactor 1 is now ready for the manufacture of silicon. This state is described as the initial state.

The doped deposition element 15 is heated using the heating device 18 and brought to a deposition temperature of 400° C. to 1200° C., particularly 800° C. to 1000° C. and particularly 900° C. The deposition of silicon onto the surface of the deposition element 15 is possible at this deposition temperature. Due to the doping of the deposition element 15, it is particularly efficient and cost-effective to heat it, since the specific resistance of the deposition element 15 has significantly decreased due to its having been doped. The deposition temperature can therefore be achieved quicker and more cost-effectively. After the deposition element 15 has been brought up to the deposition temperature, the gas 2 containing silicon, particularly monosilane or trichlorosilane, is fed into the reaction chamber 4 via the gas supply pipe 10. The supply ends 11 are arranged in the process, such that the gas 2 flows towards the inner wall 16 and rises along it towards the lid 7. Silicon is deposited while the gas 2 is flowing along the inner wall 16 of the deposition element 15, and settles on the inner wall 16. If the gas 2 reaches the lid 7, it is diverted by the flow element 14 and then flows between the outer wall 17 and the side wall 5, towards the base 6. While it is flowing along the outer wall 17, silicon is again deposited, which settles on the outer wall 17 of the deposition element 15. When the gas 2 reaches the base 6, it is discharged from the reaction chamber 4 through the gas supply pipe 12. This takes place until the deposition element 15 has reached a volume, and therefore a concentration of doping, that makes the deposition element 15 suitable for processing in photovoltaics. This state is described as the final state. As a result of the deposited silicon, the concentration in the final state compared to the concentration in the initial state has decreased; therefore the specific resistance of the deposition element 15 has increased in the final state. The deposition element 15 can now be removed from the reaction chamber 4 and further processed.

The silicon manufactured in this way is used for manufacturing silicon melt for the production of polycrystalline silicon blocks or single silicon crystals for photovoltaics, particularly for the manufacture of solar cells.

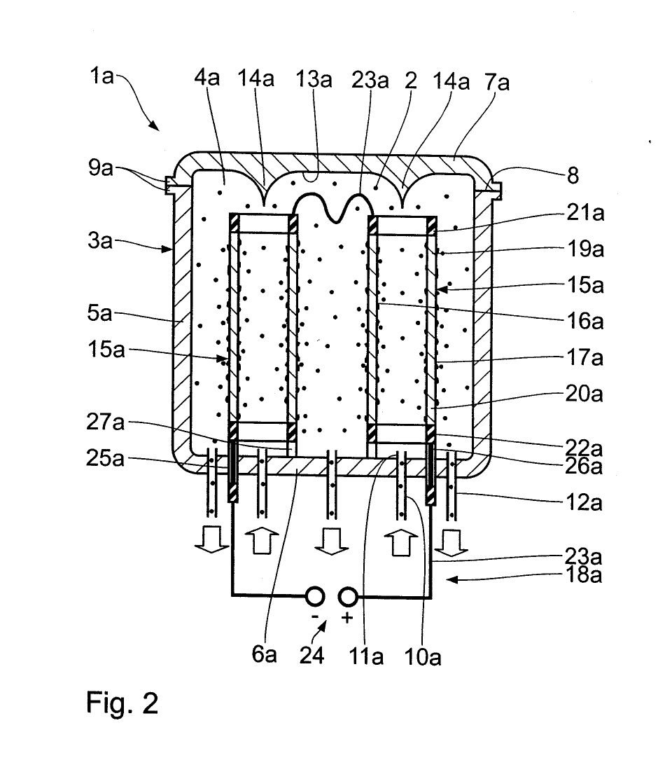

Referring to FIG. 2, a second embodiment of the invention is described hereinafter. Parts that are of identical construction have the same reference numerals as in the first embodiment, the description of which is referred to here. However, parts that are of different construction, but are functionally the same, have the same reference numerals with the suffix “a”. The substantial difference to the first embodiment is that there are two or more deposition elements 15a arranged next to each other inside the reaction chamber 4a, the following description referring to two. Both current feedthroughs 25a, 26a are arranged in the base 6a of the reactor la for the purpose of heating. The deposition elements 15a are electrically connected in series to the respective first ends 19a via a flexible connecting line 23a. The electrical connection to the poles of the voltage source 24 takes place at the respective second ends 20a. Two gas supply pipes 10a are arranged centrally to the deposition elements 15a in the region of the base 6a. The discharge of the gas 2 takes place through three or more gas discharge pipes 12a, which are arranged in the region of the base 6a, between the side wall 5a and the deposition elements 15a, and between the two deposition elements 15a. The arrangement and fixing of the deposition elements 15a takes place via bearing elements 27 in a way corresponding to that of the first embodiment. The lid 7a of the reactor 1a has two flow elements 14a arranged centrally to the deposition elements 15a and opposite the gas supply pipes 10a for diverting the gas 2 towards the base 6a. The first embodiment is referred to regarding the mode of operation of the reactor 1a and the method of manufacturing silicon.

Other possible arrangements of a plurality of deposition elements 15a are possible in principle, for example two tubular deposition elements 15a arranged inside each other.

1. Reactor for separating a gas containing silicon, comprising
a. a reactor vessel which encloses a reaction chamber for the reception of the gas and which has at least one gas supply pipe,
b. at least one heatable deposition element, arranged inside the reaction chamber for the deposition of silicon, the at least one deposition element
I. substantially containing silicon, and
ii. having a doping with at least one impurity to improve electrical conductivity, the doping having a concentration in an initial state, such that the deposition element is suitable for the manufacture of a silicon melt for the production of at least one of polycrystalline silicon blocks and single silicon crystals for photovoltaics in an end state with the silicon deposited thereon, and
c. an electrical heating device to heat the at least one deposition element using a current flow through it.

2. Reactor according to claim 1, wherein the at least one deposition element is doped with a concentration of 1.3·10¹⁷ to 1.2·10²¹ atoms per cm³.

3. Reactor according to claim 1, wherein the at least one deposition element has a first end and a second end and these are electrically conductively connected to the heating device.

4. Reactor according to claim 1, wherein the at least one deposition element is of tubular construction.

5. Reactor according to claim 4, wherein the at least one deposition element has at least a polygonal and a circular cross-section.

6. Reactor according to claim 1, wherein the at least one deposition element is constructed as a full cylinder.

7. Reactor according to claim 1, wherein the at least one deposition element has a deposition temperature of 400° C. to 1200° C. for the deposition of silicon.

8. Reactor according to claim 1, wherein the at least one deposition element has a specific resistance of 0.0001 Ohm cm to 0.17 Ohm cm.

9. Method for manufacturing silicon that is suitable as a raw material for manufacturing a silicon melt for the production of polycrystalline silicon blocks or single silicon crystals for photovoltaics, comprising the following steps:
a. provision of a reactor according to claim 1,
b. heating of the at least one deposition element using the electrical heating device to at least the deposition temperature,
c. supply of the gas containing silicon into the reactor,
d. thermal separation of the gas with the formation of silicon, and
e. deposition of the silicon onto the at least one deposition element.

10. Use of the silicon manufactured according to claim 9 for manufacturing silicon melt for the production of polycrystalline silicon blocks or single silicon crystals for photovoltaics.

11. Reactor according to claim 1, wherein the at least one deposition element is doped with a concentration of 2.7·10¹⁷ to 4.4·10²⁰ atoms per cm³ of the impurity.

12. Reactor according to claim 1, wherein the at least one deposition element is doped with a concentration of 9.5·10¹⁷ to 1.4·10²⁰ atoms per cm³ of the impurity.

13. Reactor according to claim 1, wherein the at least one deposition element has a deposition temperature of 800° C. to 1000° C. for the deposition of silicon.

14. Reactor according to claim 1, wherein the at least one deposition element has a deposition temperature of about 900° C. for the deposition of silicon.

15. Reactor according to claim 1, wherein the at least one deposition element has a specific resistance of 0.0003 Ohm cm to 0.1 Ohm cm.

16. Reactor according to claim 1, wherein the at least one deposition element has a specific resistance 0.0008 Ohm cm to 0.045 Ohm cm.
